(19) United States
(12) Patent Application Publication
(10) Pub. No.: US 2007/0186731 A1
(43) Pub. Date: Aug. 16, 2007

(54) TORQUE-ENABLING DRIVE TOOL HOLDER

(75) Inventors: Randy Schnarr, Waterloo (CA); Scott W. Allan, Kitchener (CA); Mandeep Singh, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, US

(73) Assignee: Team Fair Holdings Limited, Waterloo (CA)

(21) Appl. No.: 11/675,292

(22) Filed: Feb. 15, 2007

Related U.S. Application Data
(60) Provisional application No. 60/773,343, filed on Feb. 15, 2006.

(51) Int. Cl. B25G 1/08

(52) U.S. Cl. 81/177.4

(57) ABSTRACT

The invention is directed at a torque-enabling tool holder comprising a frame having a handle portion and a drive tool receiving portion; a plurality of tools, each having an end housed within the drive tool receiving portion; and retaining means, located within the drive tool receiving portion for receiving the end of the plurality of tools; wherein when one of the tools is rotated from a storage position to an in use position, the handle portion is used as a handle to provide an easier method for enabling torque for the tool.

### CROSS REFERENCE TO RELATED APPLICATIONS

This application claims the benefit of U.S. Provisional Application No. 60/773,343, filed Feb. 15, 2006, which is incorporated herein by reference.

### FIELD OF THE INVENTION

The present invention relates generally to hand tools. More particularly, the present invention relates to a torque-enabling drive tool holder.

### BACKGROUND OF THE INVENTION

Holders are typically used for hex keys, star drive keys (popularly known as Torx®) and other drive tools. Typically the keys/tools are a steel bar with drives on one or both ends that are formed at right angles to each other with one arm being shorter than the second arm (in an L-shape). The length of the arms is predetermined such that the tool can be used in various applications with different fastener accessibility conditions.

Holders are available but are primarily designed to serve the sole purpose of holding/storing the keys/tools. They generally comprise of a mass of plastic with holes manufactured in for holding the keys/tools. Depending on the amount of keys/tools in the set, the holders come in various sizes and shapes. Additionally, a few of these holders include hanging means for in store hanging or for use by the consumer in their workshop.

Holder products for providing torque advantage for the keys/tools are also currently available. Typically, these holders provide limited capability for the full range of keys/tools offered by many tool manufacturers. For example, the sizes used in these products are typically not less than ⅛″. Often these products comprise complicated means for locking the keys/tools in place if the consumer so chooses.

Products are also currently available that serve the dual purposes of torque advantage as well as a holder of hex keys. However, these products are not very efficient in use. For example, in use as conventional dual purpose holder, the user is required to remove the key/tool prior to placing it back into the holder prior to its use. Additionally, current holders do not provide all the strength and safeguards necessary to ensure the user is safe from injury and meet the needs of the application adequately. Many also fail to provide the capacity for a full range of tools to be stored as well as providing more functionality than just a holder and torque enable for L-shaped keys.

Furthermore, many current holders that are available are packaged in materials that are discarded and do not provide a compact design to either reduce or eliminate packaging intended for disposal.

It is, therefore, desirable to provide a torque-enabling drive tool holder and method of manufacturing same.

### SUMMARY OF THE INVENTION

It is an object of the present invention to obviate or mitigate at least one disadvantage of previous key/drive tool holders.

In a first aspect, there is provided a torque-enabling tool holder comprising a frame having a handle portion and a drive tool receiving portion; a plurality of tools, each having an end housed within the drive tool receiving portion; and retaining means, located within the drive tool receiving portion for receiving the end of the plurality of tools; wherein when one of the tools is rotated from a storage position to an in use position, the handle portion is used as a handle to provide an easier method for enabling torque for the tool.

In another aspect, there is provided a torque enabling tool holder comprising a plurality of tools having a long portion connected to a short portion in an L-shaped manner; a frame having a handle portion and a drive tool receiving portion; said drive tool receiving portion housing an end of said short portion of said plurality of tools; wherein when said tool is parallel to said handle portion, said tool is in a storage position and when said tool is substantially perpendicular to said handle portion, said tool is in an in use position.

A further aspect provides a method of enabling torque for a tool holder comprising the steps of translating an initial gripping and rotation force of a handle portion to a drive tool receiving portion; translating said force receiving at said drive tool receiving portion to a retaining means portion; translating said force received at said retaining means portion to a tool, in an in use position; and translating said force applied to said tool to enable torque to said tool holder.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of one side of a torque enabling drive tool holder in a storage position;

FIG. 2 is a perspective view of an opposite side of the torque enabling drive tool holder of FIG. 1 in the storage position;

FIG. 3 is a partial exploded view of the torque enabling drive tool holder;

FIG. 4 is a perspective view of the torque enabling drive tool holder in an in use position;

FIG. 5 is a perspective view of a second embodiment of a drive tool holder in an in use position;

FIG. 5a is a perspective view of the holder with the drive tool receiving portion exploded;

FIG. 6 is a perspective view of another embodiment of a torque-enabling drive tool holder;

FIG. 7 is a perspective of a further embodiment of a drive tool holder;

FIGS. 8 and 9 are further schematics of an embodiment of a drive tool holder;

FIG. 10 is a front view of another embodiment of the invention;

FIG. 11 is a perspective view of the embodiment of FIG. 10 in an in use position;

FIG. 12 is a perspective view of the embodiment of FIG. 10 in a storage position;

FIG. 13 is a perspective view of a further embodiment of the invention;

FIG. 14 is a perspective front view of the embodiment of FIG. 13 in an in use position;

FIG. 15 is a perspective side view of yet another embodiment of a drive tool holder in accordance with the invention;

FIG. 16 is an opposite side view of the embodiment of FIG. 15;

FIG. 17 is an exploded view of the embodiment of FIG. 15;

FIG. 18 is a perspective view of the embodiment of FIG. 15 in an in use position; and

FIG. 19 is a perspective view of a smaller tool holder; and

FIG. 20 is a flowchart outlining a method of manufacturing a torque-enabling tool holder.

### DETAILED DESCRIPTION

Generally, the present invention provides a torque-enabling drive tool holder and a method of manufacturing the holder.

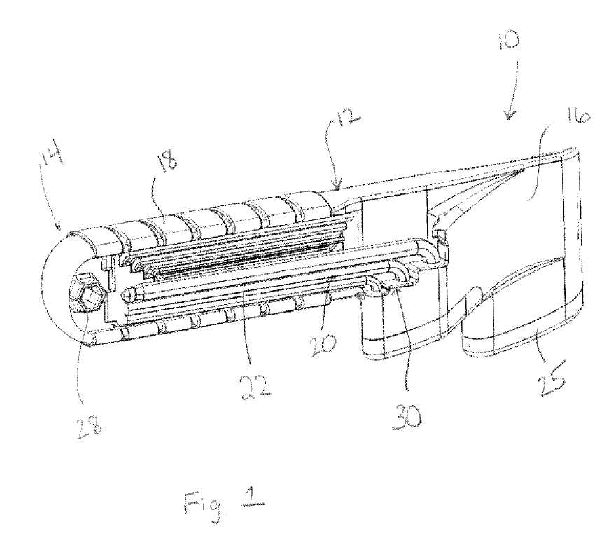

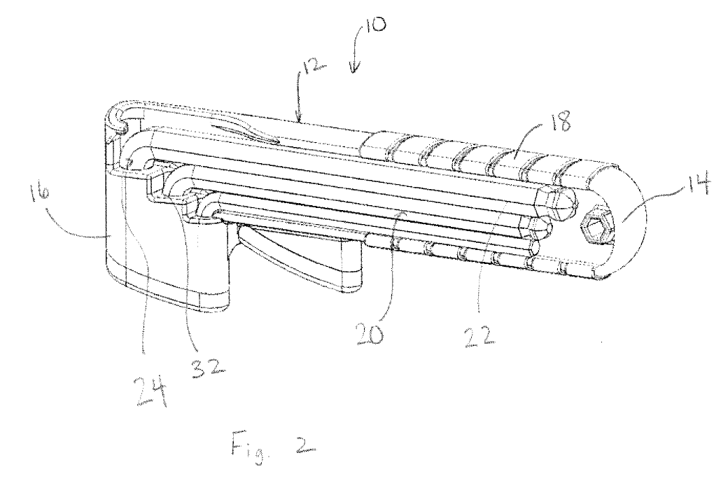

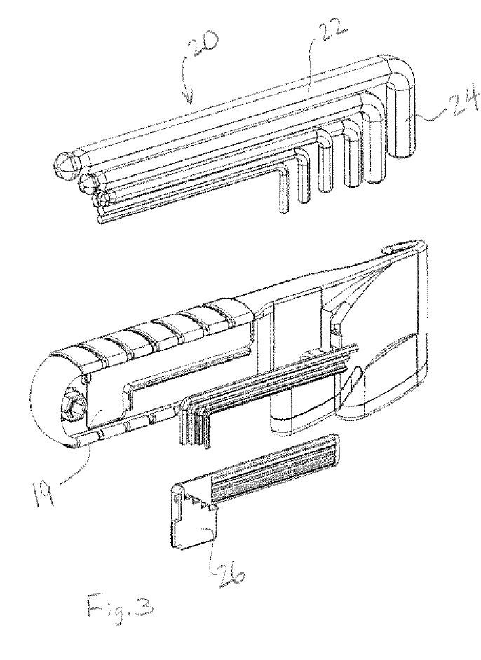

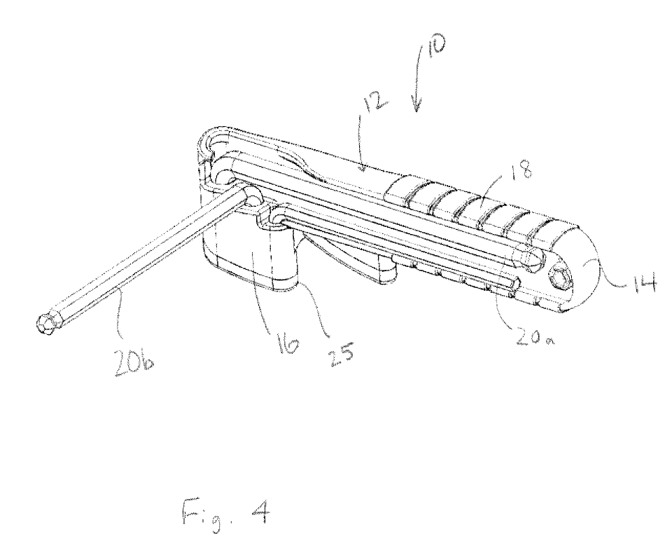

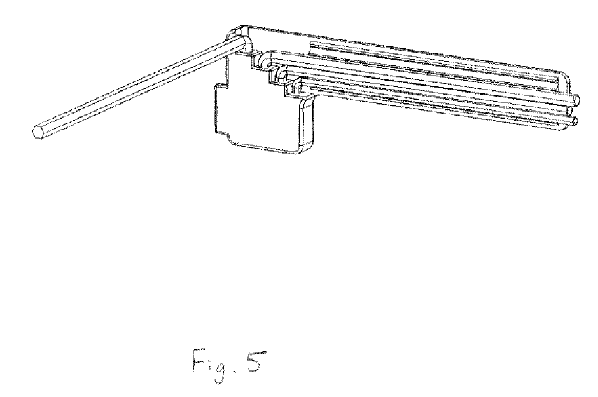

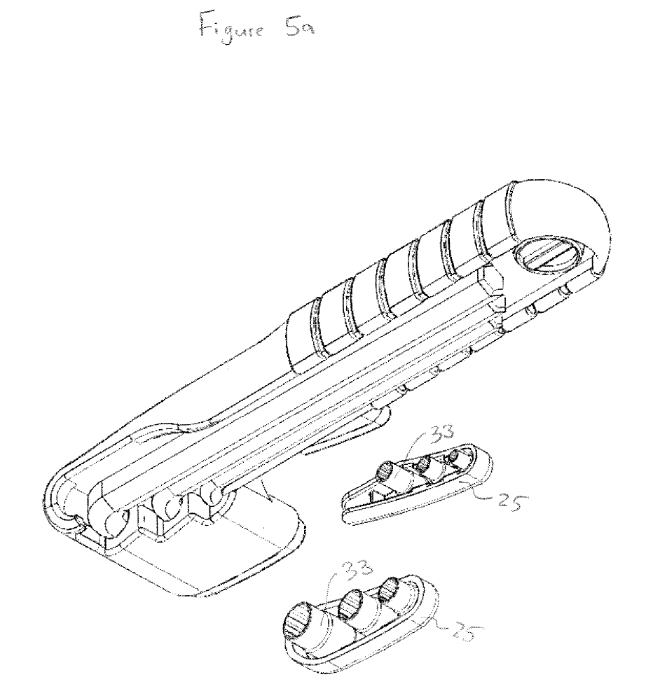

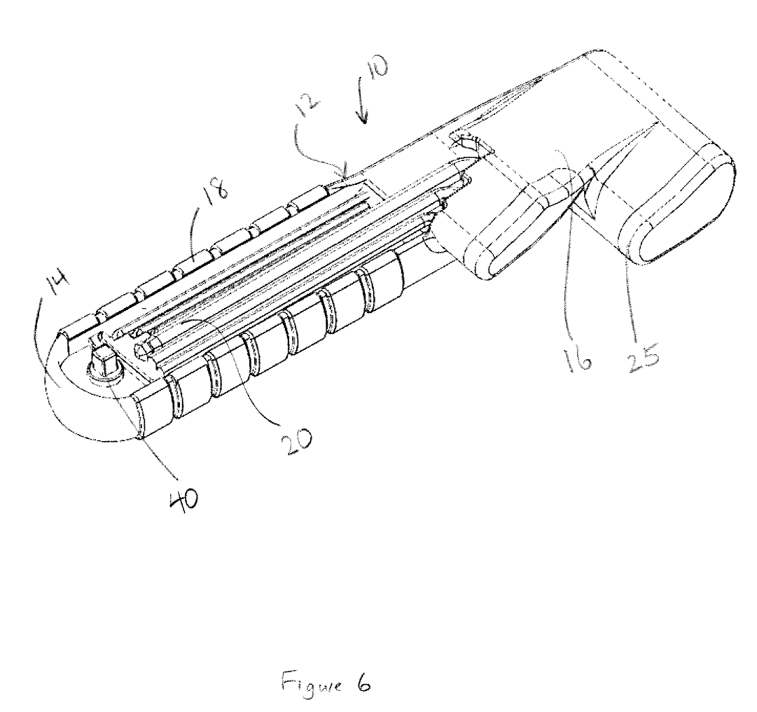

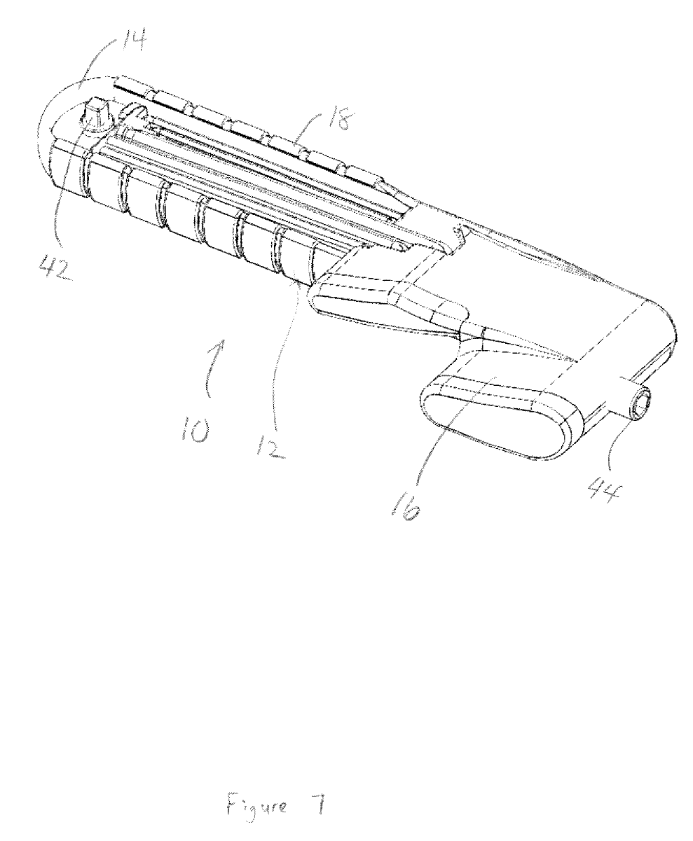

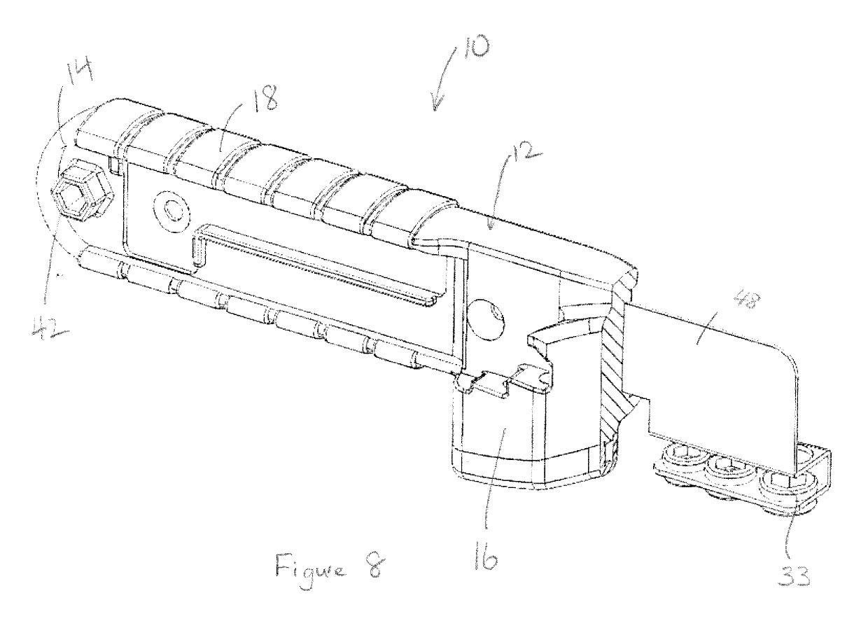

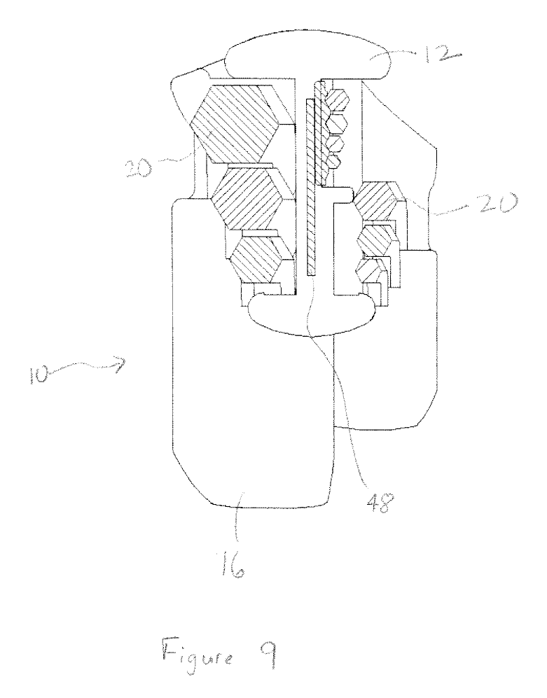

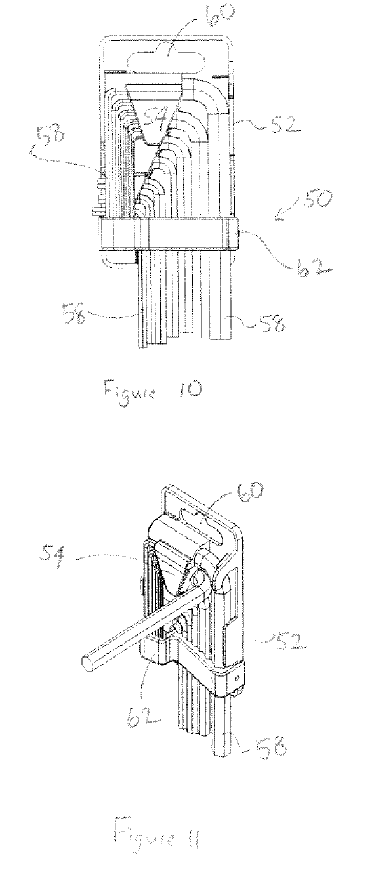

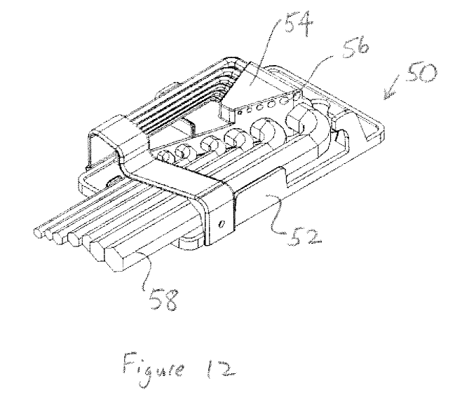

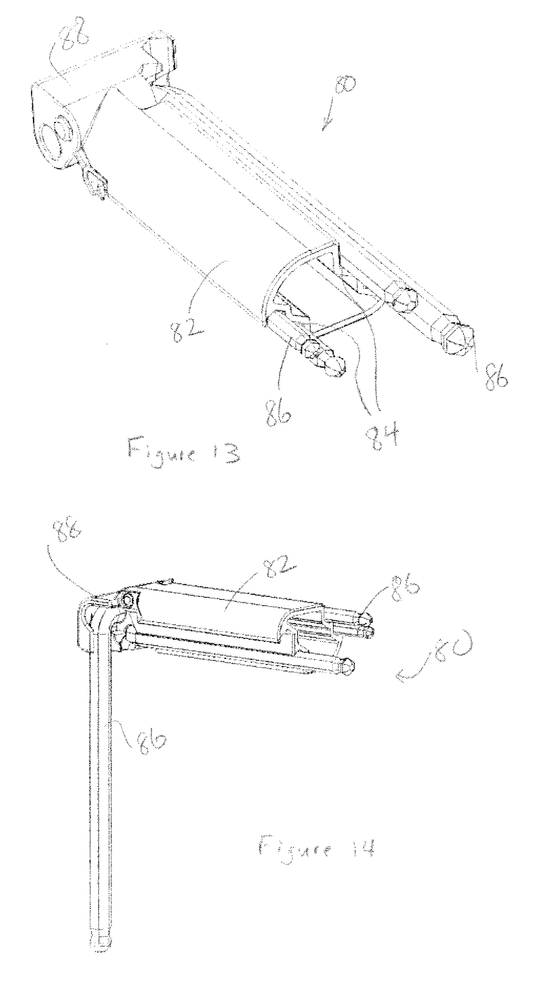

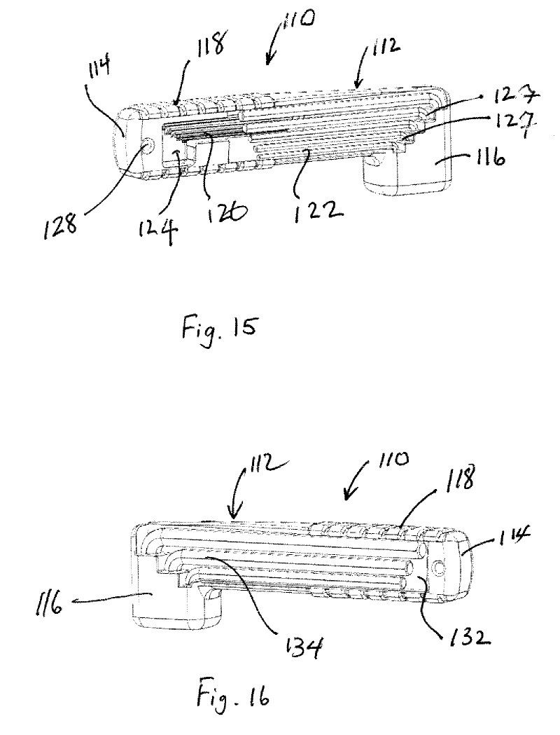

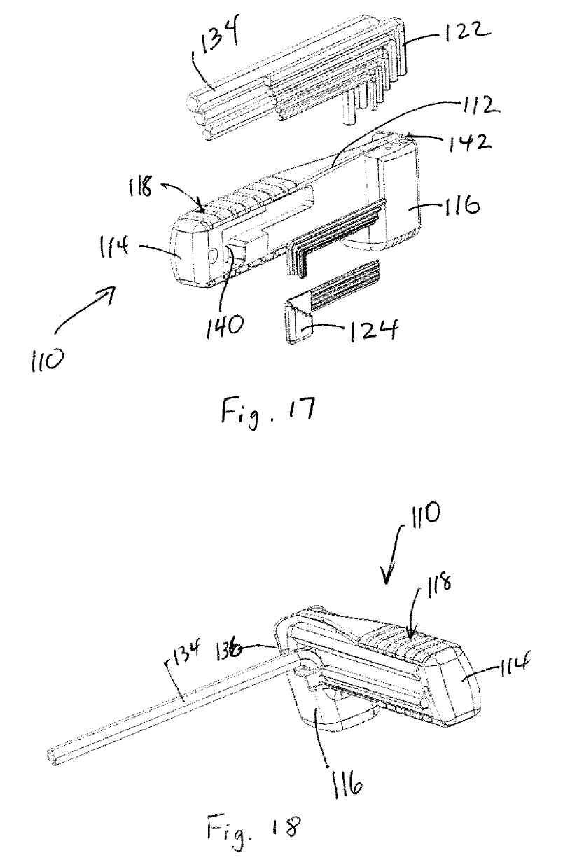

Turning to FIGS. 1 and 2, perspective views of opposing sides of a torque enabling drive tool holder are provided. The holder 10 comprises a frame 12, preferably manufactured from a rigid load bearing material, which includes a handle portion 14 and a drive tool receiving portion 16. The surface of the handle portion 14 includes a grip 18, preferably manufactured from a thermoplastic elastomer, whereby a user may grip the holder when in use, as will be discussed below. The holder 10 houses a plurality of drive tools 20, each of the drive tools 20 having a longer portion 22 connected to a shorter portion 24 in an L-shaped manner.

As shown in FIGS. 1 and 2, both sides of the handle portion 14 include an indented area 19 (shown in FIG. 3) for housing the longer portions 22 of the drive tools 20. In a preferred embodiment, on one side of the holder 10, as shown in FIGS. 1 and 3, the handle portion 14 includes an area which houses a second, smaller drive tool holder 26. When in the storage position, the longer portions 22 of the drive tools 20 assist in retaining the smaller drive tool holder 26 within the indented area 19 (as shown in FIG. 1). The smaller drive tool holder 26 may operate in the same manner as the holder 10 with the only difference being the size of the two holders. In the present embodiment, the handle portion 14 also includes a tool portion 28 which provides further benefit and functionality to the use. The tool portion 28 is shown as a hex drive with one size only but could also be increased to fit with hex bolts of varying sizes.

The shorter portion 24 of each of the drive tools 20 is housed within a holding area 30 in the drive tool receiving portion 16 of the holder 10. A cap 25 is also located beneath the area 30. The holding area 30 includes a set of holes 32 sized to receive the shorter portions 24 of the varying sized drive tools 20. By providing the area 30, all of the drive tools 20 may be housed in a single plane within the handle portion 14 allowing for an easier grip when the holder is in use. The positioning of the holes within the area 30 are selected so that the user is unable to put more torque on the drive tool for which the tool is designed when in use. The positioning of the holes is relative to the length of the long portion 22 of the drive tool 20. This is to assist in avoiding over-torque situations wherein the tools can be damaged or destroyed.

The size and shape of the holes 32 are selected so that drive tools 20 may rotate from the resting position (as shown in FIGS. 1 and 2) to an operational, or in use position (as shown in FIG. 4) and vice versa. As shown in FIG. 5a, the cap 25 includes a plurality of retaining means, seen as retaining portions, or rings, in the present embodiment, 33 which complement the holes 32 in area 30. The retaining portions are preferably made from a resilient material and sized to receive the ends of the shorter portion 24 of the drive tools 20. The retaining rings 33 provide stability to the drive tool when it is in use and also assists in preventing the drive tool from failing out of the hole 32. The resilient rings are preferably manufactured from a resilient material which is resistive to wear/tear or being misshaped. Due to the size of the smaller drive tool holder 26, it may not be necessary to include the retaining rings within the drive tool receiving portion since there is less torque applied to the holder 26 when in use. In an alternative embodiment, the holder may also receive hex keys rather than drive tools 20.

It will be understood by one skilled in the art that the drive tools may also be removed from the holder for individual use or when the user requires use of the end of the smaller portion 24 of the drive tool 20.

Turning to FIG. 4, a perspective view of the holder in an in use position is provided. In use, one of the drive tools 20 is rotated approximately 90 degrees away from its storage position. In other embodiments, the drive tool or hex key may be rotated to other angles such as 135 degrees or 180 degrees from the storage position. The end of the longer portion 22 of the drive tool 20 may then be connected with its intended target. As can be seen in FIG. 4, the other drive tools 20a assist in locking the in use drive tool 20b in place so that it does not slide out of the holder 10.

In operation, after a selected drive tool 20b has been rotated to the in use position, the user grips the grip 18 surrounding the handle portion 14 of the holder 10 and rotates the holder 10 to provide torque to the drive tool 20. There is typically contact between the user's hand and the drive tools 20a which are not in use. The direction of the rotation is dictated by whether the user wishes to loosen or tighten the intended target.

The force applied by the user on the grip 18 is translated to the handle portion 14. The force produced on the handle portion 14 is then translated to the drive tool receiving portion 16. An advantage of this embodiment is that the drive tools 20a which remain in the storage position are further assistance to the strength of the handle portion. The drive tool receiving portion 16 then translates the force from the drive tool receiving portion 14 to the retaining rings 33 and the holes 32 which hold the ends of the shorter portions of the drive tools in place in turn imparting a force which acts as torque to the drive tool so that the intended target may be loosened or tightened. Although the current embodiment demonstrates the force being translated through retaining means and the holes, it would be obvious to one skilled in the art that if the holes are able to provide resilient means for the drive tool, it would also be under the scope of this invention.

When the holder 10 is in the in use position, the frame 12 serves as a handle to provide an easier method of providing torque to the drive tool. If the user is attempting to loosen the intended target, after the target is initially loosened, the user may remove the drive tool 20b from the holder 10 by taking it out of the retaining ring to continue manually without assistance from the holder. In order to remove the drive tool from the holder 10, the drive tool is preferably placed approximately 45 degrees away from the handle portion 14 and then pulled out. Alternatively, the user may decide to keep the drive tool in the holder 10 to provide more torque while loosening the intended target. Operation of the drive tools in the smaller holder occurs in a similar manner. The in use position of the smaller drive tool holder is shown in FIG. 5.

Turning to FIG. 6, a perspective view of a further embodiment of a torque enabling drive tool holder is shown. In this embodiment, the handle portion 14 of the holder 10 includes a socket adapter portion 40 which allows the holder 10 to provide further functionality to a user. As will be understood, on the other side of the socket adapter portion 40 would be a socket direction adjustment.

Turning to FIG. 7, a perspective view of a third embodiment of a torque enabling tool holder is shown. In this embodiment, the holder 10 includes a socket wrench portion 40 within its handle portion 14 and hex adapter portion 42 at its drive tool receiving portion 16 to provide further functionality to the user.

Turning to FIGS. 8 and 9, yet a further embodiment of a torque enabling tool holder is shown. FIG. 8 is a partially broken away, perspective view while FIG. 9 is a sectional view. In this embodiment, the holder 10 further includes a flat metal insert 48 which is inserted into the frame 12 to provide further support to the holder 10 when the holder is in use. The metal insert 48 bears a portion of the load which is applied by the user on the handle portion 14 during rotation to provide further support and improved torque. In an alternative embodiment, the metal insert may be L-shaped and follow the shape of the holder 10.

As can be seen in FIG. 8, the metal insert 48 further includes the retaining means 33 which receive the ends of the shorter portions 24 of the drive tools 20. In this manner, the metal insert 48 is integral with the operation of the holder in translating the various forces from the gripping and rotation of the handle portion 14 to the torque provided to the drive tool. In the present embodiment, the metal insert provides various advantages. For one, the insert may permit the use of less rigid material typified by plastic resins being more commodity in nature therefore allowing an economical, but strong alternative for the frame. Second, as with drive tools and the intended targets, such as fasteners, the tools are intended for, there are often applications requiring extremely high torque requirements. In the case of hex keys for example, socket head cap screws, the fasteners for which the hex key drives are used in tool and die often requiring torques applying up to 75% that of the yield strength (commonly known as pre-torque) of alloy fasteners in order to place a constant tension on the joint the fastener is used in. The tension is placed on the joint so the joint remains intact and does not loosen. The metal insert, more so than any other conventional methods, enables the invention to reach such torques provide the holder is designed as such.

Turning to FIGS. 10 to 12, a further embodiment of a drive tool holder is shown. FIG. 10 provides a front view of the holder in the storage position. The drive tool key holder 50 comprises a frame 52 having mounted thereupon, a base, or drive tool receiving portion, 54 which includes a plurality of holes 56 for receiving various sized drive tools 58. As shown, a first set of drive tools 58 is located on one side of the base 54 while a second set of drive tools 58 is located on the opposite side of the base 54. The holder 50 further includes a hanging tab 60, allowing the holder 50 to be hung from a nail or a peg within a retail store and a, preferably, hinged closure 62 which provides security at a point of sale. The hinged closure 62 prevents the keys 58 from being removed from the holder 60 prior to being purchased. In the present embodiment, the base 54 is of one piece construction but alternatively may be of two-part construction so that the portion of the base 54 housing the first set of hex keys may be detached and used in a manner similar to the small hex key holder 26.

FIG. 11 provides a perspective view of the holder 50 in an in use position whereby a drive tool is rotated approximate 90 degrees from the storage position. It will be understood that the hinged closure 62 would have to be opened (or removed) in order for the key to be rotated from the storage position to the in use position. After the drive tool has been mated with its intended target, the user may then grasp the frame 52, which also serves as a handle portion, to provide a rotational force to the holder in order to apply a torque to the hex key, thereby allowing the intended target to the loosened or tightened. The force provided by the user's hand to the frame 52 (acting as the handle portion) is then translated to the base (acting as the drive tool receiving portion and the retaining rings) before providing the necessary force to torque the hex key.

As with the previous embodiment, the holder 50 preferably includes securing means to prevent the drive tools 58 from slipping out of the holder 50 which may include the other drive tools. In the present embodiment, the securing means act more as a blocking or stop so that the outermost key (adjacent the frame 52) can not be removed without being in a removal position. It will be understood that the securing means may also be used with the other embodiments.

Turning to FIGS. 13 and 14, a further embodiment of a drive tool holder is shown. The drive tool holder 80 comprises a handle portion 82 having a plurality of tool seats 84 for housing individual drive tools 86. A drive tool receiving portion 88 is connected at one end of the base 82. The handle portion and is preferably ergonomically shaped so that it conforms to a user's hand when the handle portion is gripped to loosen or tighten an intended target. When required, the drive tool 86 is rotated approximately 90 degrees from a storage position to an in use position (FIG. 13 to FIG. 14) so that the drive tool 86 may be mated with a head of a screw and then loosened (or tightened). In the in use position, the user grips the handle portion 82 and provides a rotational force which applies a torque to the hex key 86.

The force applied by the user to the handle portion is then translated to the drive tool receiving portion 88 which translates the force to the hex key, thereby enabling torque to the holder

Securing means, in the form of resilient rings located in the holes of the frame, may be used in a manner similar to that described above. Further securing means, in the form of blocking means are also located in the frame or lips to prevent the hex key from sliding or falling out of the holder 80 accidentally.

Turning to FIGS. 15 and 16, opposing side views of a torque-enabling drive tool holder is shown.

As shown in FIG. 15, the torque-enabling holder 110 comprises a frame 112, preferably made from a rigid load bearing material, having a handle portion 114 and a drive tool receiving portion 116. The surface of the handle portion 114 includes a gripping portion 118. On one side of the holder 110 (as shown FIG. 15), the handle portion 114 further includes an indented area 120 for receiving a first set of drive tools 122 and a small drive tool holder 124 which houses a second set of sized drive tools 126, which are smaller than the first set of drive tools 122. The small hex key holder 124 is preferably stored in the indented area 120 behind the first set of drive tools 122 so that the drive tools 122 assist in keeping the smaller key holder 124 from falling out of the holder 110. In order to keep the drive tools 122 from falling out, one end 127 of the drive tools 122 is placed into a correspondingly shaped hole (not shown) in the drive tool receiving portion 116 of the holder frame 112. The sets of holes are so that all of the drive tools may be all housed in a single plane within the indented area 120 of the holder 110 to provide a more compact key holder when the drive tools are in a storage position. Within each hole is a retaining means, made of a resilient material, which receives the ends of the drive tools 122.

A hanging hole 128 is provided in the frame 112 so that the key holder 110 may be hung from a nail or the like.

Turning to FIG. 16, a second side of the key holder 110 is shown. The second side also includes an indented area 132 for receiving a further set of hex keys 134. In the present embodiment, the size of each of the further set of hex keys 134 is larger than the size of each of the first set of hex keys 122. As with the first set of hex keys 122, one end of each of the further set of hex keys 134 is placed into a correspondingly shaped hole in the drive tool receiving portion 116 of the key holder frame 112 to prevent the set of hex keys 134 from accidentally falling out of the key holder 110. It will be understood that any of the keys may be manually removed from the holder for use.

As will be described in more detail below, the holes are shaped so that the sets of hex keys 122, 126 and/or 134 may be rotated approximately 90 degrees, from a storage position (FIGS. 15 and 16) to an in use position (FIG. 18) and vice versa.

FIG. 17 provides an exploded view of the key holder 110 and the small hex key holder 124 where each of the parts described above are more clearly shown. As can be seen in the figure, the indented area 120 further includes a housing 140 within it for receiving the small hex key holder 124. The set of holes 142 are also seen in this figure.

FIG. 18 shows the holder in the in use position with one of the hex keys from the further set of hex keys 134 rotated away from the holder 110. In order to prevent the hex key 134 from over-rotating, stops 136 are provided on the frame 112 of the holder 110 to stop the hex key from rotating past a predetermined position. The preferred position of the hex key is to be perpendicular to the plane of the handle portion 114.

The user may then connect the end of the key 134 with a head of a screw (not shown) to be loosened (or tightened). Once connected, the user grips the gripping portion 118 and provides a rotational force (thereby producing torque) to loosen (or tighten) the screw.

The force applied by the user on the gripping portion 118 is translated to the handle portion 114. The force produced on the handle portion 114 is then translated to the drive tool receiving portion 116. The drive tool receiving portion 116 then translates this force to the retaining means which hold the hex keys 122, 126 or 134 in place. The force translated to the retaining means is then translated as torque to the hex key 122, 126 or 134 so that the screw may be tightened or loosened similar to the manner discussed above.

When the holder is in the in use position, the frame 112 serves as a handle to provide an easier method of providing torque to the selected hex key. If the user is attempting to loosen the screw, after the screw is initially loosened, the user may remove the hex key from the holder 110 by taking it out of the retaining ring/hole to continue the loosening of the screw. Alternatively, the user may decide to keep the hex key in the holder 110 to provide a larger gripping surface while loosening the screw. Operation of the small hex keys 124 in the small holder 126 occurs in a similar manner.

As further shown in FIG. 18, when the hex key 134 is in the in use position, the key 134 is secured in place by the retaining means within the holes 142. The retaining means may include the hex keys being kept in place by adjacent keys, blocking means or a resilient material to provide a friction fit for the hex key within the hole 142. The retaining means provides one advantage in that the hex key 134 is locked in place and can only be removed from the hole 142 by force. Another advantage is that when a hex key is rotated from the storage to the in use position, the retaining means or resilient material ring provides support so that the hex key will not slide in and out of the hole 142. In use, the hex key 134 is blocked from movement by the other adjacent hex keys.

In another embodiment, securing, or detent, means are mounted to the frame 112 of the holder 110. It will be understood that a combination of the many different of retaining means are also contemplated for use with the holder 110. In general, the retaining means are used to preferably prevent a hex key 134 from slipping out of the holder 110 when it is being used to loosen (or tighten) a screw or when it is simply in the storage position.

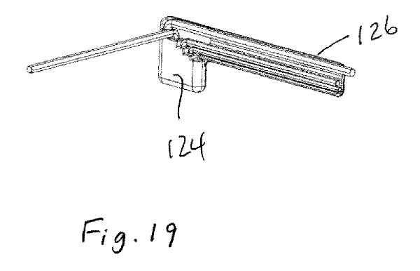

FIG. 19 shows the small hex key holder 126 in an in use position whereby one of the small hex keys 126 may be mated with a correspondingly shaped head of a screw so that the screw may be loosened or tightened.

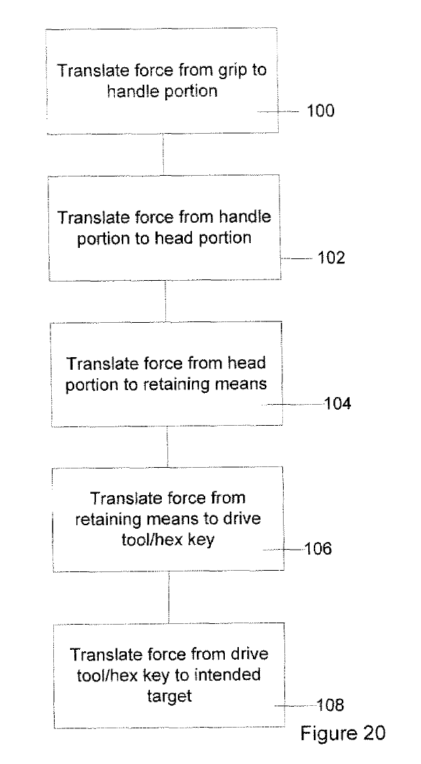

Turning to FIG. 20, a flowchart outlining a method of enabling torque for a drive tool holder is shown. As has been described above after the tool holder is placed in the in use position with one of the drive tools or hex keys rotated from the storage position to the in use position, the user grips the handle portion of the holder, and more preferably via the grip. As discussed above, the grip is preferably manufactured from a soft, friction material. The force from the hand is then translated from the grip to the handle portion (step 100) which is manufactured from a rigid, high strength material. If there is no grip, the force applied by the hand is imparted directly to the handle portion. Furthermore, the drive tools which remain in the storage position are also provide further support to the handle portion and assist in receiving the force applied by the user. After receiving the force at the handle portion, this force is then translated to the drive tool receiving portion (step 102). After receiving the force at the drive tool receiving portion, the drive tool receiving portion translates this force to the retaining rings (step 104) which hold the drive tool or hex key in place. The retaining rings are preferably made from a material having a relatively strong compression strength and notch resistant properties. The resiliency of the material used allows for the drive tool to be held in place within the holder while in use while the high compression strength of the material provide for the load transfer which is experienced when the holder is in use. The retaining rings receive the end of the short portion of the drive tool or hex key. The force is then translated from the retaining ring to the short portion of the drive tool/hex key (step 106) which then translates the force to the longer portion of the drive tool or hex key enabling the holder to impart a torque to the intended target. Therefore the gripping and rotation of the handle port by the user is translated to a torquing force.

In general, each of the embodiments of the invention comprises similar features in that the holder can be used for holding drive tools or hex keys and for use as a handle allowing for an easier way to provide torque to the drive tool or hex key. When the user has an application for the hex key, or tool, wherein the longer arm is required, the user has the option to use the tool freely (removing the key from the holder) or if additional torque is required the holder can be used to leverage the extra force required as described above with respect to the in use positions of the embodiments. Additionally, the hex keys, or tools, are placed such that the keys and the strength therefrom may be used to assist in the overall bending strength of the holder.

During the application of force to the holder, there are several loads the holder undergoes. The initial force from the user's hand to the holder, the transfer of the load from the holder (acting as the handle) to the frame or drive tool receiving portion of holder and the transfer of the forces from the drive tool receiving portion to the end of the hex key contacting the screw. Each of the load applications are different and requires different methods of bearing such loads. The initial force for the user's hand to the holder requires ergonomic considerations, more specifically softness, forming and load distribution to the hand. The transfer from the holder (as the handle) to the short portion of the hex key in the base of frame requires bending and some torsion strength thereby dictating stiffness and torsion resistance and the drive tool receiving portion requiring stiffness and bearing strength as well as friction and resilient material for holding the hex key or tool in place for proper use. Having said this, the materials utilized are varied throughout the embodiments to include a material(s) adequate for ergonomics, materials(s) adequate for bending and torsion resistance, material(s) adequate for stiffness and bearing strength and materials for friction and resilience. In some case materials may be suited to different applications. Depending on the type of application and type of hex key or tools, any combination of these disclosed, and similar type, materials, are contemplated for use in the holder, base and frame.

In some of the embodiments, the holders are manufactured from one or more materials in accordance with the loads being applied to the holder when in the storage or in use positions. For instance, the grip portion of the holder is preferably manufactured from a softer material to provide ergonomic support to the user in use.

As described above, the holder preferably includes securing means to keep the tools secured to the holder. In the operation for driving a fastener, in one embodiment, this may be accomplished with a user-activated mechanism ie. a lever, a lock etc (not shown), by design means in the example of the adjacent tools securing the tool in use or by other means such as using friction materials in interfaces between the hey key/tool and the holder (acting as the handle). All of which preferably intended to keep the tools affixed to the handle or removably secure. Additionally, during the storage as well as the use of the holder, it is preferable to keep the tools not being used in place. Various means can again be utilized and include detent means or friction means.

Alternatively, the holder is designed so that all differently sizes keys may benefit from an easier method of applying torque to the key. Although small tools are typically not able to withstand as high torque loads as larger keys, the requirement for torque advantage in some applications remains. Furthermore, the design provides scaled-down designs to avoid over-torque or misuse by the user. As shown in one embodiment, the small holder is preferably stored within the hex key holder.

In an alternative embodiment of the invention, instead of hex keys, other types of keys, such as start drive keys or other driving tools may be used.

Alternatively, the holders may include detent means for holding the hex keys when they are in the storage position from inadvertent displacement.

Alternatively, the holders may include means for connecting to another holder.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A torque-enabling tool holder comprising:
a frame having a handle portion and a drive tool receiving portion;
a plurality of tools, each having an end housed within said drive tool receiving portion; and
retaining means, located within said drive tool receiving portion for receiving said end of said plurality of tools;
wherein when one of said tools is rotated from a storage position to an in use position, said handle portion is used as a handle to provide an easier method for enabling torque for said tool.

2. The holder of claim 1 wherein when said one of said tools is in said in use position, said other of said plurality of tools provide further rigidity to said handle portion.

3. The holder of claim 1 wherein said retaining means comprises:
a set of holes within said drive tool receiving portion; and
retaining portions corresponding to said set of holes, manufactured from a resilient material.

4. The holder of claim 3 wherein said retaining portions are a set of retaining rings.

5. The holder of claim 1 wherein said handle portion further comprises a grip surrounding said handle portion.

6. The holder of claim 1 further comprising:
a second torque enabling tool holder, sized to fit within said handle portion of said holder.

7. The holder of claim 1 further comprising:
an additional tool element to provide further functionality to said holder.

8. The holder of claim 7 wherein said additional tool element is a socket adapter.

9. The holder of claim 8 wherein said additional tool element is a hex adapter.

10. The holder of claim 1 further comprising a metal insert, located within said frame for providing support to said holder.

11. A torque enabling tool holder comprising:
a plurality of tools having a long portion connected to a short portion in an L-shaped manner;
a frame having a handle portion and a drive tool receiving portion; said drive tool receiving portion housing an end of said short portion of said plurality of tools;
wherein when said tool is parallel to said handle portion, said tool is in a storage position and when said tool is substantially perpendicular to said handle portion, said tool is in an in use position.

12. The holder of claim 11 wherein when said tool is in an in use position, force applied to said handle portion is translated to said drive tool receiving portion which, in turn translates said force to said end of said short portion of said tool which, in turn applies said force to said long portion of said tool to enable torque for said holder.

13. A method of enabling torque for a tool holder comprising the steps of:
translating an initial gripping and rotation force of a handle portion to a drive tool receiving portion;
translating said force receiving at said drive tool receiving portion to a retaining means portion;
translating said force received at said retaining means portion to a tool, in an in use position; and
translating said force applied to said tool to enable torque to said tool holder.
